(19) United States
(12) Patent Application Publication
(10) Pub. No.: US 2021/0303970 A1
(43) Pub. Date: Sep. 30, 2021

(54) PROCESSING DATA USING MULTIPLE NEURAL NETWORKS

(71) Applicant: SAP SE, Walldorf (DE)

(72) Inventors: Ke Ma, Shanghai (CN); Atreya Biswas, Singapore (SG)

(21) Appl. No.: 16/835,669

(22) Filed: Mar. 31, 2020

(51) Int. Cl. G06N 3/04; G06N 3/08; G06Q 20/40; G06Q 40/00; G06Q 40/02

(52) U.S. Cl. CPC G06N 3/0454; G06N 3/08; G06Q 40/02; G06Q 40/125; G06Q 20/40

(57) ABSTRACT

As discussed herein, multiple neural networks are each trained on time-series data from a different domain. Each of the trained neural networks is used to make a domain-specific prediction for each point in time. Thus, time-series prediction data is generated by each of the trained neural networks. The domain-specific time-series prediction data are combined into a vector and used to train a final model that predicts a value. By breaking down the problem of forecasting into domain-specific forecasting models and a forecasting model, accuracy is improved over traditional document-based forecasting and computational resources are saved over traditional neural network designs.

### TECHNICAL FIELD

The subject matter disclosed herein generally relates to processing data using multiple neural networks.

### BACKGROUND

Neural networks are a set of algorithms that are designed to recognize patterns. They interpret data through a kind of machine perception, labeling or clustering raw input. The input data is numerical, contained in vectors. The output data is also numerical, but, depending on the application, can be translated into images, sound, text, or time-series data.

### BRIEF DESCRIPTION OF THE DRAWINGS

Some embodiments are illustrated by way of example and not limitation in the figures of the accompanying drawings.

FIG. 1 is a network diagram illustrating a network environment suitable for processing data using multiple neural networks, according to some example embodiments.

FIG. 2 is a block diagram of a neural network training server, according to some example embodiments, suitable for training multiple neural networks to process data.

FIGS. 3-4 are block diagrams of a database schema, according to some example embodiments, suitable for use in processing data using multiple neural networks.

FIG. 5 illustrates the training and use of a neural network, according to some example embodiments.

FIG. 6 illustrates the structure of a neural network, according to some example embodiments.

FIG. 7 is a block diagram illustrating the use of multiple neural networks on data from different domains to generate a final result, according to some example embodiments.

FIG. 8 is a flowchart illustrating operations of a method suitable for training multiple neural networks to predict liquidity, according to some example embodiments.

FIG. 9 is a flowchart illustrating operations of a method suitable for using multiple neural networks to predict liquidity and generate a user interface based on the predicted liquidity, according to some example embodiments.

FIG. 10 is a block diagram showing one example of a software architecture for a computing device.

FIG. 11 is a block diagram of a machine in the example form of a computer system within which instructions may be executed for causing the machine to perform any one or more of the methodologies discussed herein.

### DETAILED DESCRIPTION

Example methods and systems are directed to data prediction using multiple neural networks. In an example embodiment, the prediction may be liquidity that relates to the cash (or readily negotiable instruments) of a business. Mid-term (one month to one year) and long-term (over one year) liquidity prediction is difficult because the document-based methods, used for short-term (one month or less) liquidity prediction, fail. Document-based short-term liquidity prediction considers invoices, sales orders, and other documents, projects a probability of the indicated funds transfer taking place by the time of the short-term forecast, and aggregates the individual predictions to generate a liquidity prediction. Since the mid- and long-term liquidity time period extends beyond the time period for which documents are created, the methods used for short-term liquidity prediction are not effective for mid- and long-term predictions. It is however to be appreciated that the multiple neural network structure discussed herein may be used for other types of data prediction or classification.

One possible solution to predict liquidity using neural networks would be to use the historical cash position of a business over a period of time to train a neural network. The neural network is used to predict future liquidity based on the cash position to date. However, such a neural network has been found to be insufficiently reliable.

An alternative solution would be to generate a vector of time-series data from multiple domains (e.g., economic data for a political region, economic data for a currency, economic data for divisions of the business, economic data for the business as a whole, or any suitable combination thereof) and use this vector to train a neural network. However, such a neural network would require a great deal of training data and consume substantial or prohibitive computational resources.

As discussed herein, multiple neural networks are each trained on time-series data from a different domain. Each of the trained neural networks is used to make a domain-specific prediction for each point in time. Thus, time-series prediction data is generated by each of the trained neural networks, also referred to as models. The domain-specific time-series prediction data are combined into a vector and used to train a final model that predicts mid- and long-term liquidity. By breaking down the problem of liquidity forecasting into domain-specific forecasting models and a liquidity model, accuracy is improved over traditional document-based forecasting and computational resources are saved over traditional neural network designs.

When these effects are considered in aggregate, one or more of the methodologies described herein may obviate a need for certain efforts or resources that otherwise would be involved in liquidity prediction. Computing resources used by one or more machines, databases, or networks may similarly be reduced. Examples of such computing resources include processor cycles, network traffic, memory usage, data storage capacity, power consumption, and cooling capacity.

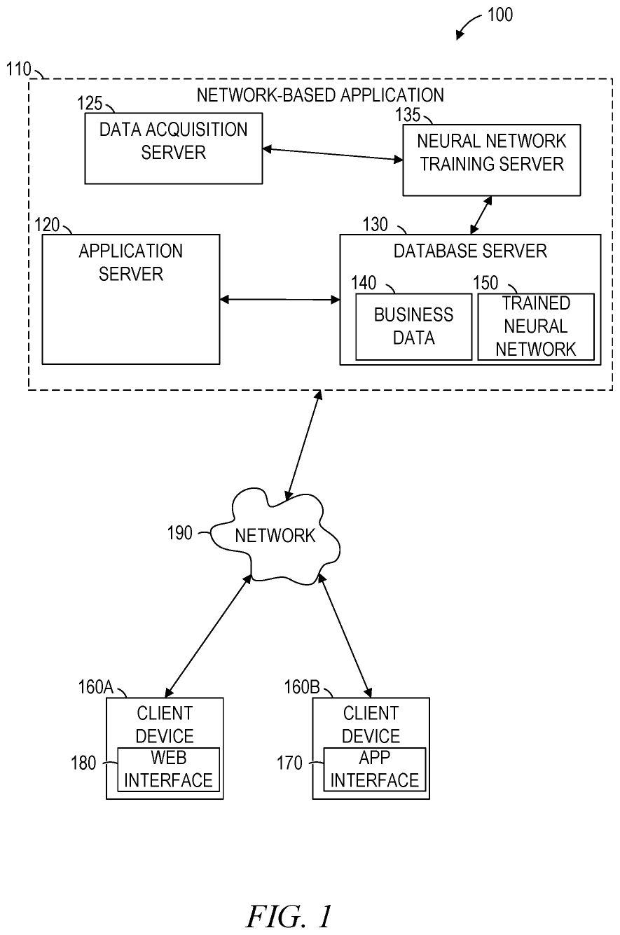

FIG. 1 is a network diagram illustrating a network environment 100 suitable for processing data using multiple neural networks, according to some example embodiments. The network environment 100 includes a network-based application 110, client devices 160A and 160B, and a network 190. The network-based application 110 is provided by an application server 120 in communication with a database server 130, storing business data 140 and a trained neural network 150.

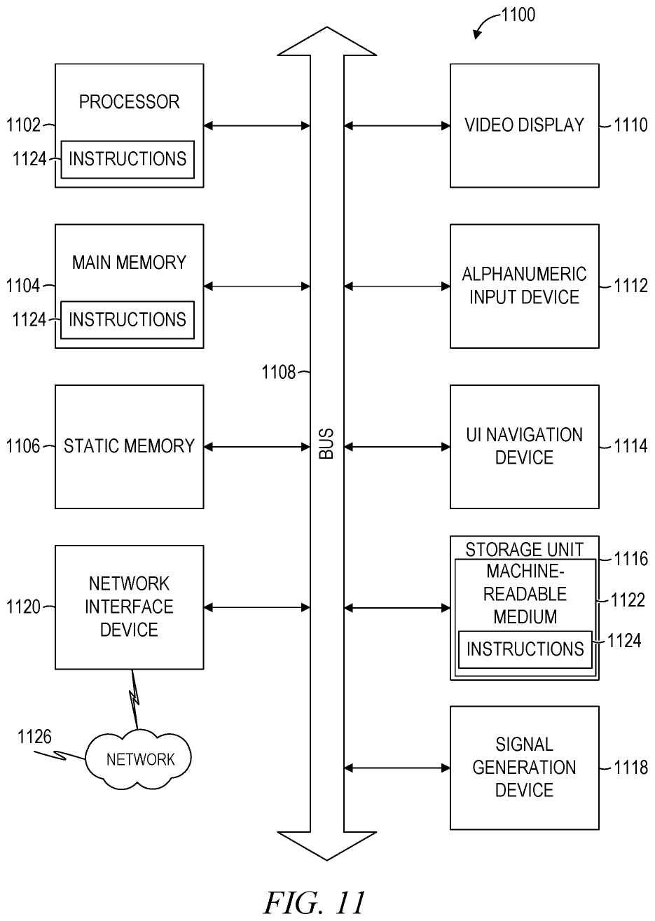

The application server 120 accesses the business data 140 to provide an application to the client devices 160A and 160B via a web interface 180 or an application interface 170. The application server 120, the data acquisition server 125, the database server 130, the neural network training server 135, and the client devices 160A and 160B may each be implemented in a computer system, in whole or in part, as described below with respect to FIG. 11. The client devices 160A and 160B may be referred to collectively as client devices 160 or generically as a client device 160.

The data acquisition server 125 receives data from one or more data sources. The received data is provided to the neural network training server 135 for training one or more neural networks. The trained neural networks are transferred to the database server 130 and stored as the trained neural network 150. The application server 120 causes the trained neural network 150 to process the business data 140 to generate a liquidity forecast. The liquidity forecast is provided by the application server 120 to a client device 160 via the network 190 for display to a user. Additionally or alternatively, the liquidity forecast is used by the application server 120 to automatically control further operations of the application server 120. For example, a credit line to the business may be automatically extended or denied based on the liquidity forecast.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the data acquisition server 125, the database server 130, the neural network training server 135, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

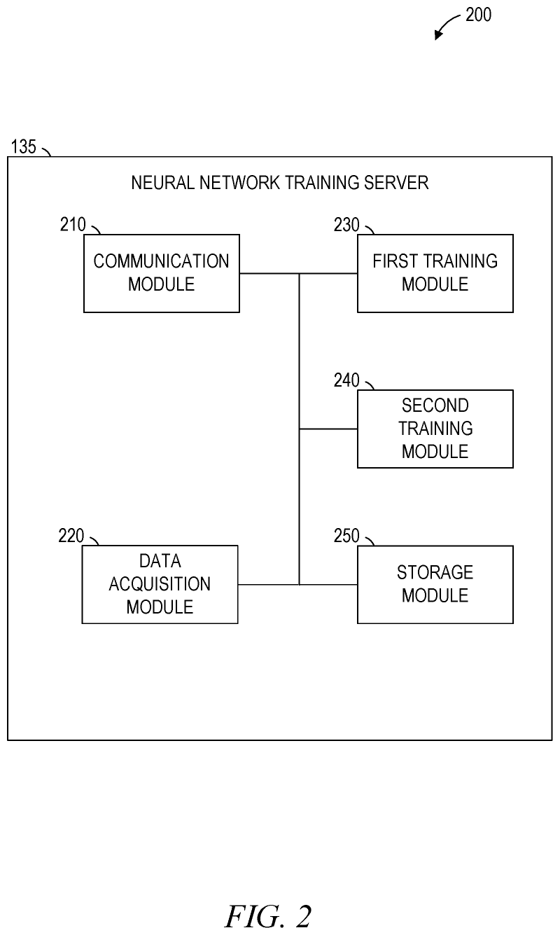

FIG. 2 is a block diagram 200 of the neural network training server 135, according to some example embodiments, suitable for training multiple neural networks to process data. The neural network training server 135 is shown as including a communication module 210, a data acquisition module 220, a first training module 230, a second training module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the neural network training server 135 and transmits data from the neural network training server 135. For example, the communication module 210 receives, from the data acquisition server 125, domain data for one or more domains (e.g., data for dollar-based trade, data for Germany, data for a business unit, or any suitable combination thereof) and provides the domain data to the data acquisition module 220.

The data acquisition module 220 receives the domain data from the data acquisition server 125 or from multiple such data acquisition servers. The received domain data is processed by the data acquisition module 220 into a format suitable for training neural networks.

The first training module 230 trains a neural network using domain data from a domain. Multiple first training modules 230 may be present, each training a neural network for a different domain. Each of the first training modules 230 generates time-series data, each element of which is a prediction for a value in the domain (e.g., a prediction of future dollar-based trade data, a prediction of future data for Germany, a prediction of future data for a business unit, or any suitable combination thereof). The second training module 240 trains a neural network using outputs from one or more of the first training modules 230. The second training module 240 provides, via the communication module 210, a trained neural network for predicting liquidity.

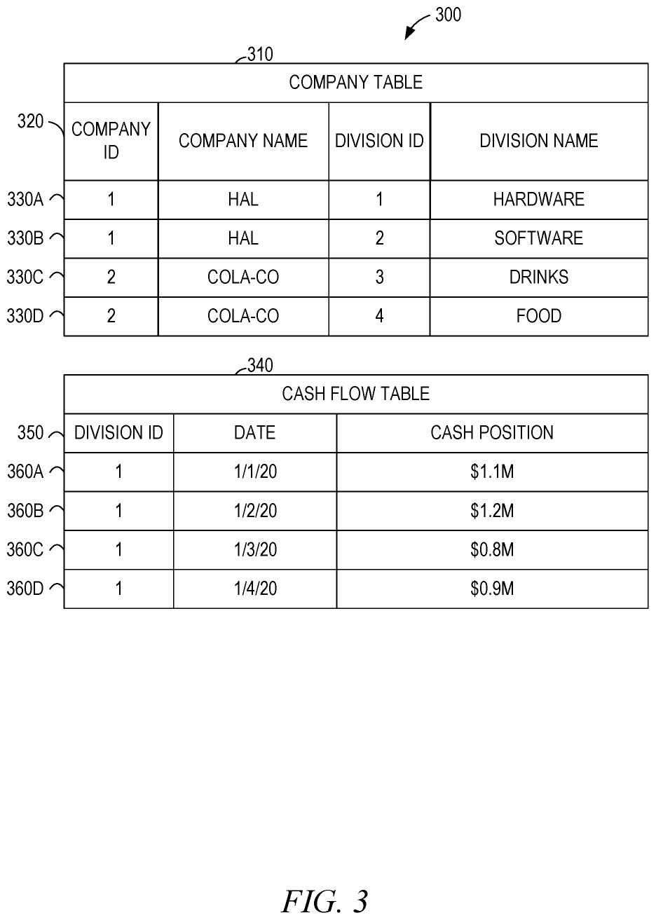

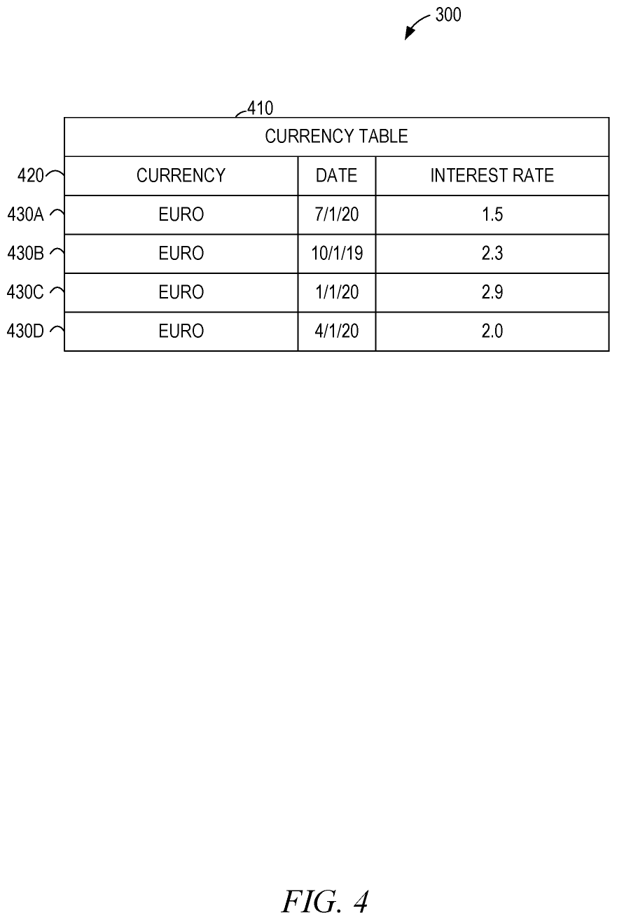

FIGS. 3-4 are block diagrams of a database schema 300, according to some example embodiments, suitable for use in processing data using multiple neural networks. The database schema 300 includes a company table 310, a cash flow table 340, and a currency table 410. The company table 310 includes rows 330A, 330B, 330C, and 330D of a format 320. The cash flow table 340 includes rows 360A, 360B, 360C, and 360D of a format 350. The currency table 410 includes rows 430A, 430B, 430C, and 430D of a format 420. The data acquisition server 125 processes raw data from the domain sources to generate data for the tables of the schema 300.

The format 320 of the company table 310 includes a company identifier field, a company name field, a division identifier field, and a division name field. Each of the rows 330A-330D stores data for a single division. The company identifier is a unique identifier for each company. The company name is a human-readable name for the company. Thus, the rows 330A and 330B relate to the company HAL and the rows 330C and 330D each relate to the company COLA-CO. The division identifier is a unique identifier for each division. The division name is a human-readable name for the division. Thus, the row 330A is for the HARDWARE division of HAL; the row 330B identifies the SOFTWARE division of HAL; the row 330C identifies the DRINKS division of COLA-CO; and the row 330D identifies the FOOD division of COLA-CO.

The format 350 of the cash flow table 340 includes a division identifier field, a date field, and a cash position field. Thus, each of the rows 360A-360D contains one element of time-series data for the cash position of a division. In the example of FIG. 3, the four rows 360A-360D contain the daily cash position for the HARDWARE division of HAL. The unique division identifier is used to relate the data in the cash flow table 340 to the division and company identified in the company table 310.

The format 420 of the currency table 410 includes a currency field, a date field, and an interest rate field. Thus, each of the rows 430A-430D contains one element of time-series data for the interest rate of a currency. In the example of FIG. 4, the four rows 430A-430D contain the quarterly interest rates for the EURO currency.

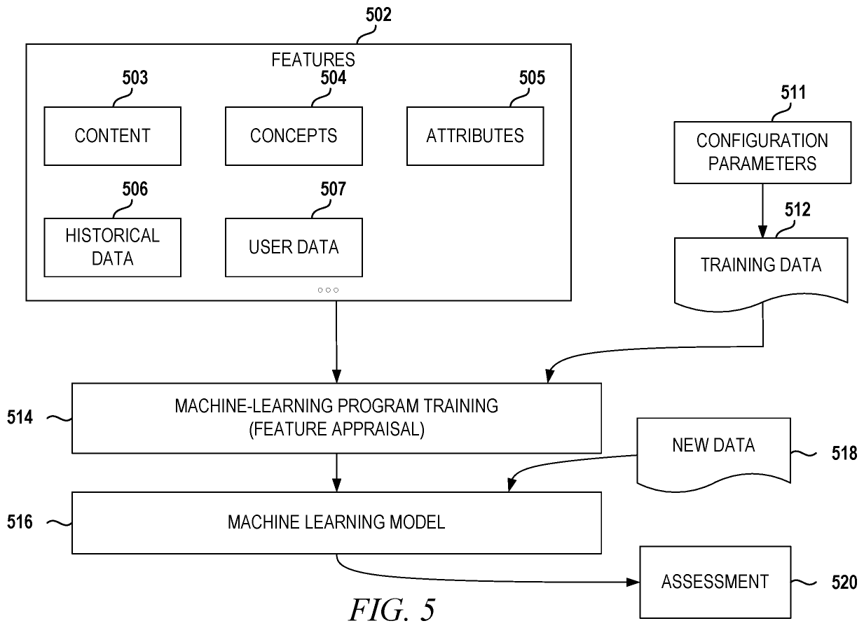

FIG. 5 illustrates the training and use of a neural network, according to some example embodiments. In some example embodiments, machine-learning programs (MLPs), also referred to as machine-learning algorithms or tools, are utilized to perform operations associated with economic forecasts, such as mid- and long-term liquidity prediction.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 516 from example training data 512 in order to make data-driven predictions or decisions expressed as outputs or assessments 520. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data.

During a learning phase, the models are developed against a training dataset of inputs to optimize the models to correctly predict the output for a given input. Generally, the learning phase may be supervised, semi-supervised, or unsupervised, indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset. The goal of supervised ML is to learn a function that, given some training data, best approximates the relationship between the training inputs and outputs so that the ML model can implement the same relationships when given inputs to generate the corresponding outputs. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a real number score for an input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some embodiments, example ML model 516 provides a liquidity prediction as a value measured in currency units (e.g., euros) or as a probability of having liquidity sufficient to meet obligations (e.g., a percentage value from 0 to 100).

The training data 512 comprises examples of values for the features 502. In some example embodiments, the training data 512 comprises labeled data with examples of values for the features 502 and labels indicating the outcome, such as valid or invalid email address, email address bounced, typographical errors, etc. The machine-learning algorithms utilize the training data 512 to find correlations among identified features 502 that affect the outcome. A feature 502 is an individual measurable property of a phenomenon being observed. The concept of a feature is related to that of an explanatory variable used in statistical techniques such as linear regression. Further, deep features represent the output of nodes in hidden layers of the deep neural network. Choosing informative, discriminating, and independent features is important for effective operation of ML in pattern recognition, classification, and regression. Features may be of different types, such as numeric features, strings, and graphs.

In one example embodiment, the features 502 may be of different types and may include one or more of content 503, concepts 504, attributes 505, historical data 506, and/or user data 507, merely for example.

During training 514, the ML algorithm analyzes the training data 512 based on identified features 502 and configuration parameters 511 defined for the training 514. The result of the training 514 is an ML model 516 that is capable of taking inputs to produce assessments.

Training an ML algorithm involves analyzing large amounts of data (e.g., from several gigabytes to a terabyte or more) in order to find data correlations. The ML algorithms utilize the training data 512 to find correlations among the identified features 502 that affect the outcome or assessment 520. In some example embodiments, the training data 512 includes labeled data, which is known data for one or more identified features 502 and one or more outcomes. For example, in training an ML algorithm for image recognition, a labeled dataset comprising images and a corresponding category for each image may be used. As another example, in training an ML algorithm for language translation, a labeled dataset comprising text in a first language and corresponding text in a second language may be used. As a third example, in training an ML algorithm to prioritize messages, a labeled dataset comprising the messages and an urgency rating may be used.

As a fourth example, the training data 512 is time-series data comprising a sequence of values and the output of the machine learning model 516 is a predicted next value of the sequence. For example, 256 previous values may be used as an input feature and the 257^{th} value used as the labeled output. Using different values in the time-series data as the starting position, many training examples can be generated from the dataset. For example, in a sequence of 2000 observations, 1743 training elements of size 256 can be obtained.

The ML algorithms usually explore many possible functions and parameters before finding what the ML algorithms identify to be the best correlations within the data; therefore, training may require large amounts of computing resources and time.

Many ML algorithms include configuration parameters 511, and the more complex the ML algorithm, the more parameters there are that are available to the user. The configuration parameters 511 define variables for an ML algorithm in the search for the best ML model. The training parameters include model parameters and hyperparameters. Model parameters are learned from the training data, whereas hyperparameters are not learned from the training data, but instead are provided to the ML algorithm.

Some examples of model parameters include maximum model size, maximum number of passes over the training data, data shuffle type, regression coefficients, decision tree split locations, and the like. Hyperparameters may include the number of hidden layers in a neural network, the number of hidden nodes in each layer, the learning rate (perhaps with various adaptation schemes for the learning rate), the regularization parameters, types of nonlinear activation functions, and the like. Finding the correct (or the best) set of hyperparameters can be a very time-consuming task that requires a large amount of computer resources.

When the ML model 516 is used to perform an assessment, new data 518 is provided as an input to the ML model 516, and the ML model 516 generates the assessment 520 as output. For example, the new data 518 may be data for a business entity and the assessment 520 may be a mid- or long-range liquidity forecast for the business entity.

Feature extraction is a process to reduce the amount of resources required to describe a large set of data. When performing analysis of complex data, one of the major problems is one that stems from the number of variables involved. Analysis with a large number of variables generally requires a large amount of memory and computational power, and it may cause a classification algorithm to overfit to training samples and generalize poorly to new samples. Feature extraction includes constructing combinations of variables to get around these large-data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or a similar, amount of information.

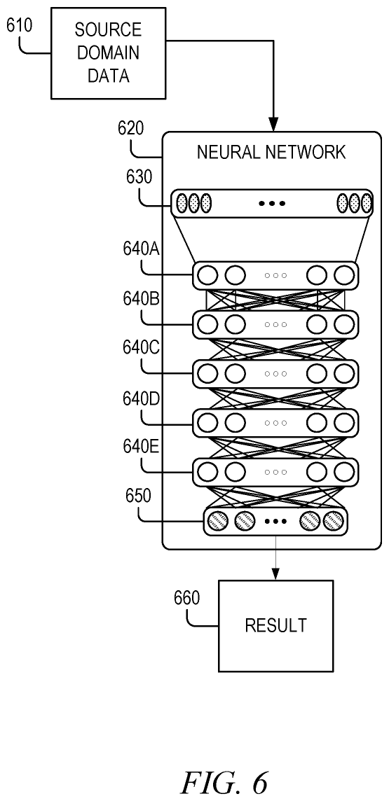

FIG. 6 illustrates the structure of a neural network 620, according to some example embodiments. The neural network 620 takes source domain data 610 as input, processes the source domain data 610 using the input layer 630; the intermediate, hidden layers 640A, 640B, 640C, 640D, and 640E; and the output layer 650 to generate a result 660.

Each of the layers 630-650 comprises one or more nodes (or “neurons”). The nodes of the neural network 620 are shown as circles or ovals in FIG. 6. Each node takes one or more input values, processes the input values using zero or more internal variables, and generates one or more output values. The inputs to the input layer 630 are values from the source domain data 610. The output of the output layer 640 is the result 660. The intermediate layers 640A-640E are referred to as “hidden” because they do not interact directly with either the input or the output, and are completely internal to the neural network 620. Though five hidden layers are shown in FIG. 6, more or fewer hidden layers may be used.

A model may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the model is evaluated and the values of its variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

The neural network 620 may be a deep learning neural network, a deep convolutional neural network, a recurrent neural network, or another type of neural network. A neuron is an architectural element used in data processing and artificial intelligence, particularly machine learning, that includes memory that may determine when to “remember” and when to “forget” values held in that memory based on the weights of inputs provided to the given neuron. An example type of neuron in the neural network 620 is a Long Short Term Memory (LSTM) node. Each of the neurons used herein are configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance are related to one another.

For example, an LSTM serving as a neuron includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural Networks

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

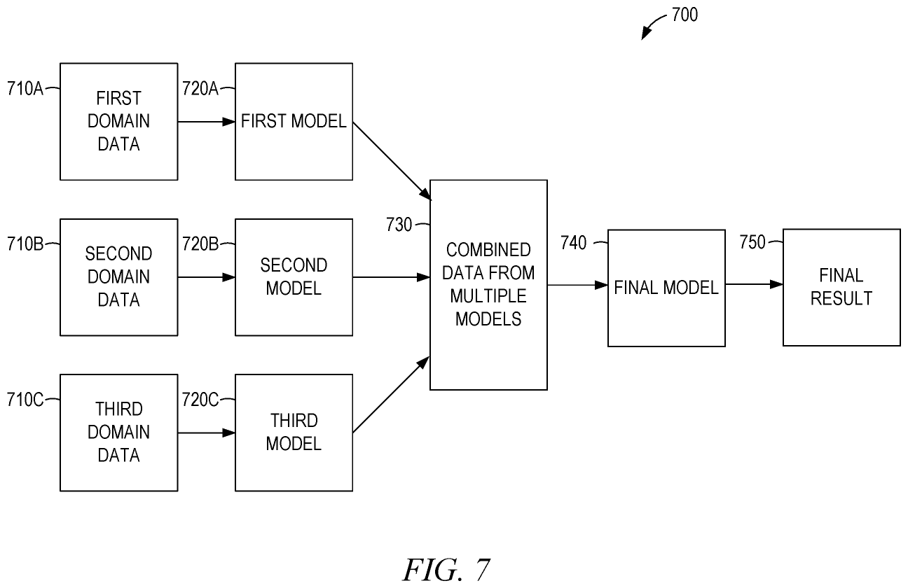

FIG. 7 is a block diagram 700 illustrating the use of multiple neural networks on data from different domains to generate a final result, according to some example embodiments. A first model 720A operates on first domain data 710A; a second model 720B operates on second domain data 710B; and a third model 720C operates on third domain data 710C. Results generated by the models 720A-720C are combined into the data 730. The final model 740 operates on the data 730 to generate the final result 750. In some example embodiments, each of the domain data 710A-710C is time-series data. The time-series data may be at any granularity (e.g., daily, weekly, monthly, quarterly, yearly, or any suitable combination thereof).

For example, the first domain data 710A may be data for a political region (e.g., a country, state, economic union, or any suitable combination thereof). Based on the first domain data 710A, the first model 720A makes a prediction for economic performance of the political region. In some example embodiments, the prediction is time-series data indicating a predicted economic performance of the political region for each of a number of future time steps. The time steps may be at any granularity (e.g., daily, weekly, monthly, quarterly, yearly, or any suitable combination thereof).

As another example, the second domain data 710B may be data for a currency (e.g., euros). Based on the second domain data 710B, the second model 720B makes a prediction for economic performance of the currency. In some example embodiments, the prediction is time-series data indicating a predicted economic performance of the currency for each of a number of future time steps.

As a third example, the third domain data 710C may be data for a business or a subsidiary or division thereof. Example third domain data 710C includes accounts receivable data, payroll data, accounts payable data, or any suitable combination thereof. Based on the third domain data 710C, the third model 720C makes a prediction for economic performance of the business, subsidiary, or division. In some example embodiments, the prediction is time-series data indicating a predicted economic performance of the business, subsidiary, or division for each of a number of future time steps.

The combined data 730 may be formed as time-series data for which data at each time step is represented as a vector. The vector contains one entry for each of the models 720A-720C. The final result 750 generated by the final model 740 operating on the combined data 730 is a liquidity forecast, either for a set point in time or as time-series data.

Though three sets of domain data 710A-710C and three models 720A-720C are shown in FIG. 7, more or fewer domains may be used. For example, a forecast for a business with many subsidiaries may make use of a model for each subsidiary, each currency the business or its subsidiaries makes use of, each political region the business or its subsidiaries does business in, or any suitable combination thereof. Additionally, though a two-level hierarchy of models is shown in FIG. 7, additional levels may be used. For example, the three models 720A-720C may be used to generate time series data for a division, the model 740 may be used to predict the performance of the division, and multiple division-prediction models may be aggregated into data analogous to the data 730 for processing by another model that predicts the performance of an overall business.

In prior art systems in which liquidity forecasting is performed directly on corporate cash flow data, the results have high noise and low accuracy. By considering additional data instead of only the aggregate corporate cash flow, greater accuracy results. In some example embodiments, separate models are used for each division or subsidiary of the corporation, and the final model 740 uses the results from those models to generate the final result 750 for the cash flow of the corporation. A second hierarchy, within each division or subsidiary, may be by data source (e.g., Associated Press, Bureau of Labor Statistics, World Bank, International Monetary Fund, Yahoo! ® Finance, Google® Finance, or any suitable combination thereof), by currency (e.g., dollar, euro, yen, yuan, or any suitable combination thereof), by political region (e.g., the European Union, the United States, China, or any suitable combination thereof).

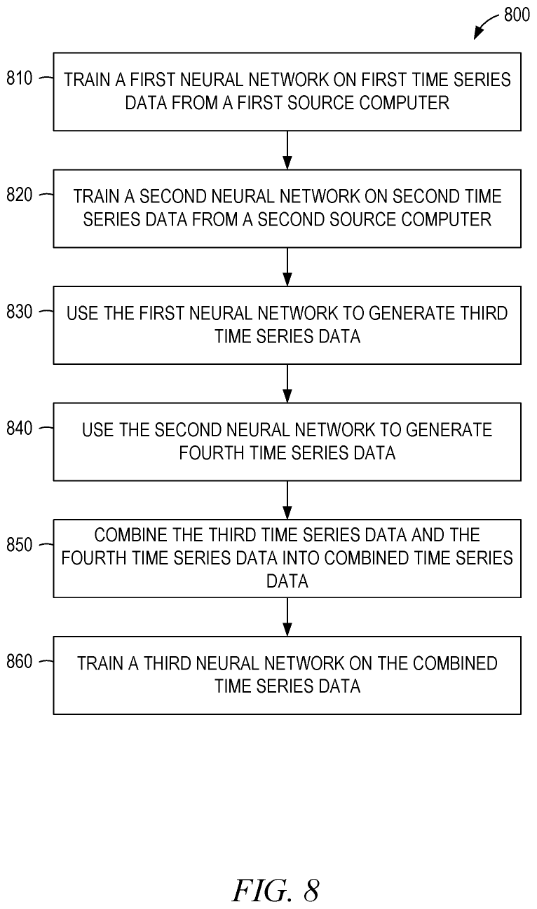

FIG. 8 is a flowchart illustrating operations of a method 800 suitable for training multiple neural networks to predict liquidity, according to some example embodiments. The method 800 includes operations 810, 820, 830, 840, 850, and 860. By way of example and not limitation, the method 800 is described as being performed in the network environment 100 of FIG. 1 by the neural network training server 135 described in FIG. 2 using the database schema 300 of FIGS. 3-4, using neural networks as shown in FIGS. 5-6.

In operation 810, the first training module 230 trains a first neural network (e.g., the first model 720A) on first time series data from a first source computer. The first source computer may provide publicly-available, subscription-access data, or proprietary data for a political region. The first time series data may comprise one or more of gross domestic product (GDP), government debt amount, government bond interest rate, unemployment rate, average wage, or any combination or derivative thereof.

The first training module 230, in operation 820, trains a second neural network (e.g., the second model 720B) on second time series data from a second source computer. The second source computer may provide publicly-available, subscription-access data, or proprietary data for a currency. The second time series data may comprise one or more of total currency flow, exchange rate, or any combination or derivative thereof.

The second training module 240 uses the first and second neural networks, in operations 830 and 840, to generate third and fourth time series data, respectively. As an example, the first neural network generates time-series data that is a prediction of the future values of the first time series data and the second neural network generates time-series data that is a prediction of the future values of the second time series data.

In operation 850, the second training module 240 combines the third time series data and the fourth time series data into combined time series data. If the third and fourth time-series data are at the same granularity (e.g., one value for each day), the combination operation may create a vector for each pair without further modification. However, if the third and fourth time-series data are at different granularities (e.g., the third time-series data is a daily forecast and the fourth time-series data is a weekly forecast), one or both of the series is modified for combination. For example, a weekly forecast value may be reused seven times and treated as a daily forecast value. This conversion would be suitable for a measure such as government debt amount or unemployment rate. Alternatively, a weekly forecast value may be divided by seven and treated as a daily forecast value. This conversion would be suitable for a measure such as a change in GDP or unemployment rate.

The second training module 240, in operation 860, trains a third neural network (e.g., the final model 740) on the combined time series data. Thus, the third neural network is trained to generate a final result based on the output generated by other neural networks instead of based on the underlying data.

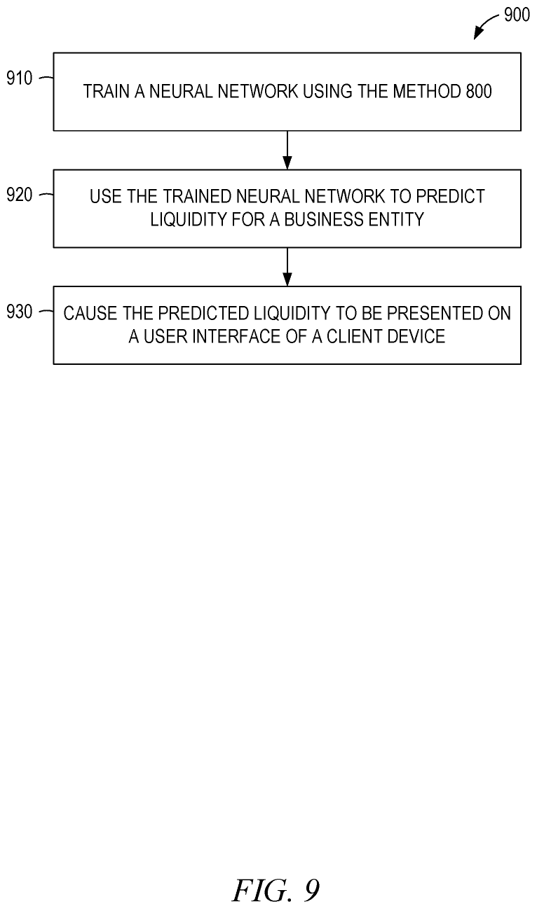

FIG. 9 is a flowchart illustrating operations of a method 900 suitable for using multiple neural networks to predict liquidity and generate a user interface based on the predicted liquidity, according to some example embodiments. The method 900 includes operations 910, 920, and 930. By way of example and not limitation, the method 900 is described as being performed in the network environment 100 of FIG. 1 by the neural network training server 135 described in FIG. 2 using the database schema 300 of FIGS. 3-4, using neural networks as shown in FIGS. 5-6.

In operation 910, the neural network training server 135 trains a neural network (e.g., the final model 740) using the method 800. The application server 120, in operation 920, uses the trained neural network to predict liquidity for a business entity. For example, the ability of a business to meet its obligations may be predicted as weekly time-series data for the period of one to six months in the future.

The application server 120 causes the predicted liquidity to be presented on a user interface of a client device (operation 930). For example, the predicted liquidity may be transmitted to the client device 160A via the network 190 for display in the web interface 180. The predicted liquidity may be displayed as numeric values, a graph, or both.

In some example embodiments, in addition to or instead of operation 930, the application server 120, based on the predicted liquidity, automatically approves or denies a financial transaction with the business entity. For example, a loan may be approved or denied based on the predicted liquidity.

### EXAMPLES

Example 1. A method comprising:

generating, by a first neural network taking features derived from first time series data from a first source computer as input, second time series data;
generating, by a second neural network taking features derived from third time series data from a second source computer as input, fourth time series data;
combining the second time series data and the fourth time series data into combined time series data;
generating, by a third neural network taking features derived from the combined time series data as input, a predicted value; and
causing the predicted value to be presented on a user interface of a client device.

Example 2. The method of example 1, further comprising:

based on the predicted value, automatically approving a financial transaction with a business entity.

Example 3. The method of example 1, further comprising:

based on the predicted value, automatically denying a financial transaction with a business entity.

Example 4. The method of any one of examples 1 to 3, further comprising:

accessing the first time series data from the first source computer via a network; and
creating a training set for the first neural network by treating a predetermined number of sequential values of the first time series data as an input and a following value of the first time series data as a label for the input.

Example 5. The method of any one of examples 1 to 4, wherein the first time series data comprises daily interest rate data.

Example 6. The method of any one of examples 1 to 4, wherein the first time series data comprises monthly growth data.

Example 7. The method of any one of examples 1 to 6, wherein the predicted value is a predicted liquidity of a business entity.

Example 8. The method of example 7, wherein the first time series data is weekly liquidity data for a subsidiary of the business entity.

Example 9. The method of example 7, wherein the first time series data is quarterly time series data for a currency.

Example 10. The method of example 7, wherein the first time series data comprises daily accounts receivable data.

Example 11. The method of example 7, wherein the first time series data comprises monthly payroll data of the business entity.

Example 12. A system comprising:

a memory that stores instructions; and
one or more processors configured by the instructions to perform operations comprising:
generating, by a first neural network taking features derived from first time series data from a first source computer as input, second time series data;
generating, by a second neural network taking features derived from third time series data from a second source computer as input, fourth time series data;
combining the second time series data and the fourth time series data into combined time series data;
generating, by a third neural network taking features derived from the combined time series data as input, a predicted value; and
causing the predicted value to be presented on a user interface of a client device.

Example 13. The system of example 12, wherein the operations further comprise:

based on the predicted value, automatically approving a financial transaction with a business entity.

Example 14. The system of example 12, wherein the operations further comprise:

based on the predicted value, automatically denying a financial transaction with a business entity.

Example 15. The system of any one of examples 12 to 14, wherein the first time series data comprises daily interest rate data.

Example 16. The system of any one of examples 12 to 14, wherein the first time series data comprises monthly growth data.

Example 17. The system of any one of examples 12 to 16, wherein the predicted value is a predicted liquidity of a business entity.

Example 18. A non-transitory machine-readable medium that stores instructions that, when executed by one or more processors, cause the one or more processors to perform operations comprising:

generating, by a first neural network taking features derived from first time series data from a first source computer as input, second time series data;
generating, by a second neural network taking features derived from third time series data from a second source computer as input, fourth time series data;
combining the second time series data and the fourth time series data into combined time series data; generating, by a third neural network taking features derived from the combined time series data as input, a predicted value; and causing the predicted value to be presented on a user interface of a client device.

Example 19. The non-transitory machine-readable medium of example 18, wherein the operations further comprise:

based on the predicted value, automatically approving a financial transaction with a business entity.

Example 20. The non-transitory machine-readable medium of example 18, wherein the operations further comprise:

based on the predicted value, automatically denying a financial transaction with a business entity.

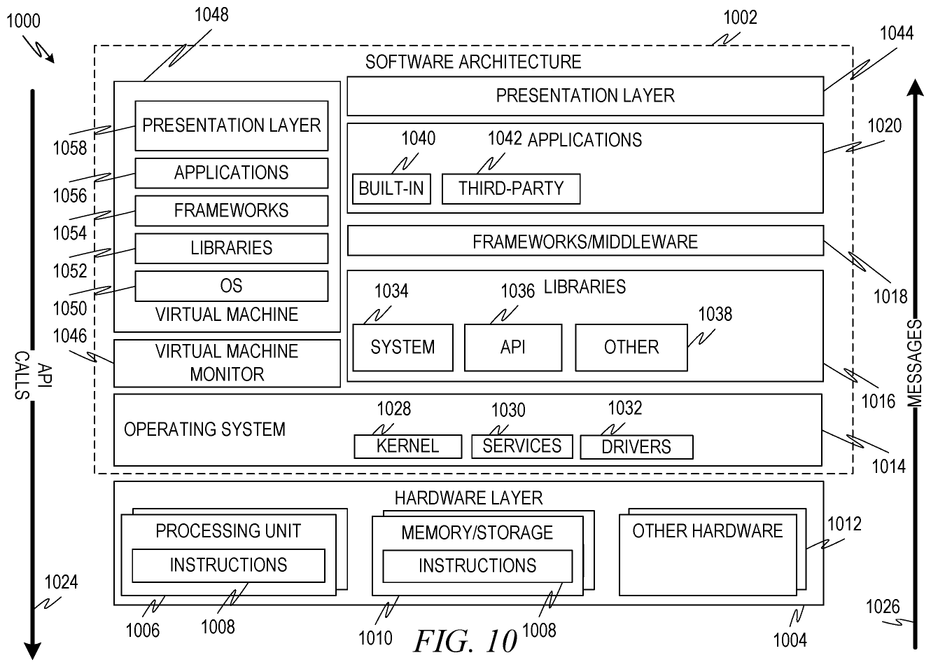

FIG. 10 is a block diagram 1000 showing one example of a software architecture 1002 for a computing device. The architecture 1002 may be used in conjunction with various hardware architectures, for example, as described herein. FIG. 10 is merely a non-limiting example of a software architecture and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 10.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 which represents any other hardware of the hardware layer 1004, such as the other hardware illustrated as part of the software architecture 1002.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020 and presentation layer 1044. Operationally, the applications 1020 and/or other components within the layers may invoke application programming interface (API) calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphic user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. Third-party applications 1042 may include any of the built-in applications 1040 as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™ Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built in operating system functions (e.g., kernel 1028, services 1030 and/or drivers 1032), libraries (e.g., system libraries 1034, API libraries 1036, and other libraries 1038), frameworks/middleware 1018 to create user interfaces to interact with users of the system. Alternatively, or additionally, in some systems interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine as well as the interface with the host operating system (i.e., operating system 1014). A software architecture executes within the virtual machine 1048 such as an operating system 1050, libraries 1052, frameworks/middleware 1054, applications 1056 and/or presentation layer 1058. These layers of software architecture executing within the virtual machine 1048 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram of a machine in the example form of a computer system 1100 within which instructions 1124 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation (or cursor control) device 1114 (e.g., a mouse), a storage unit 1116, a signal generation device 1118 (e.g., a speaker), and a network interface device 1120.

### Machine-Readable Medium

The storage unit 1116 (e.g., a disk drive) includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting machine-readable media 1122.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. A machine-readable medium is not a transmission medium.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
generating, by a first neural network taking features derived from first time series data from a first source computer as input, second time series data;
generating, by a second neural network taking features derived from third time series data from a second source computer as input, fourth time series data;
combining the second time series data and the fourth time series data into combined time series data;
generating, by a third neural network taking features derived from the combined time series data as input, a predicted value; and
causing the predicted value to be presented on a user interface of a client device.

2. The method of claim 1, further comprising:
based on the predicted value, automatically approving a financial transaction with a business entity.

3. The method of claim 1, further comprising:
based on the predicted value, automatically denying a financial transaction with a business entity.

4. The method of claim 1, further comprising:
accessing the first time series data from the first source computer via a network;
creating a training set for the first neural network by treating a predetermined number of sequential values of the first time series data as an input and a following value of the first time series data as a label for the input; and
training the first neural network using the training set.

5. The method of claim 1, wherein the first time series data comprises daily interest rate data.

6. The method of claim 1, wherein the first time series data comprises monthly growth data.

7. The method of claim 1, wherein the predicted value is a predicted liquidity of a business entity.

8. The method of claim 7, wherein the first time series data is weekly liquidity data for a subsidiary of the business entity.

9. The method of claim 7, wherein the first time series data is quarterly time series data for a currency.

10. The method of claim 7, wherein the first time series data comprises daily accounts receivable data.

11. The method of claim 7, wherein the first time series data comprises monthly payroll data of the business entity.

12. A system comprising:
a memory that stores instructions; and
one or more processors configured by the instructions to perform operations comprising:
generating, by a first neural network taking features derived from first time series data from a first source computer as input, second time series data;
generating, by a second neural network taking features derived from third time series data from a second source computer as input, fourth time series data;
combining the second time series data and the fourth time series data into combined time series data;
generating, by a third neural network taking features derived from the combined time series data as input, a predicted value; and
causing the predicted value to be presented on a user interface of a client device.

13. The system of claim 12, wherein the operations further comprise:
based on the predicted value, automatically approving a financial transaction with a business entity.

14. The system of claim 12, wherein the operations further comprise:
based on the predicted value, automatically denying a financial transaction with a business entity.

15. The system of claim 12, wherein the first time series data comprises daily interest rate data.

16. The system of claim 12, wherein the second time series data comprises monthly growth data.

17. The system of claim 12, wherein the predicted value is a predicted liquidity of a business entity.

18. A non-transitory machine-readable medium that stores instructions that, when executed by one or more processors, cause the one or more processors to perform operations comprising:
generating, by a first neural network taking features derived from first time series data from a first source computer as input, second time series data;
generating, by a second neural network taking features derived from third time series data from a second source computer as input, fourth time series data;
combining the second time series data and the fourth time series data into combined time series data;
generating, by a third neural network taking features derived from the combined time series data as input, a predicted value; and
causing the predicted value to be presented on a user interface of a client device.

19. The non-transitory machine-readable medium of claim 18, wherein the operations further comprise:
based on the predicted value, automatically approving a financial transaction with a business entity.

20. The non-transitory machine-readable medium of claim 18, wherein the operations further comprise:
based on the predicted value, automatically denying a financial transaction with a business entity.
